(19) United States
(12) Patent Application Publication
(10) Pub. No.: US 2021/0035091 A1
(43) Pub. Date: Feb. 4, 2021

(54) SECURE REVISING OF MOBILE WALLET ELEMENTS

(71) Applicant: Wells Fargo Bank, N.A., San Francisco, CA (US)

(72) Inventors: Joon Maeng, Newcastle, WA (US); Ramanathan Ramanathan, Bellevue, WA (US); Thomas Hayes, Katy, TX (US)

(21) Appl. No.: 15/362,524

(22) Filed: Nov. 28, 2016

(51) Int. Cl. G06Q 20/36; G06Q 20/38; G06Q 20/32

(52) U.S. Cl. CPC G06Q 20/3674; G06Q 20/3829; G06Q 2220/00; G06Q 20/3825; G06Q 20/3226

(57) ABSTRACT

Various examples are directed to systems and methods for secure revision of an element of a mobile wallet. The wallet element includes a revision signature and revision instructions that the mobile wallet may use to determine a revision action for the mobile wallet element. After determining a revision action, the mobile wallet may identify an issuer of the wallet element using the revision instructions and send a message to the issuer. The message may for example include a revision request corresponding to the revision action along with the revision signature of the mobile wallet element. The mobile wallet may send the message to the issuer and receive a response that includes revised wallet element data. The mobile wallet may revise the wallet element based on the revised wallet element data. This may include replacing the wallet element with a new one, updating an expiration data, replace software or updating functionality of the wallet element, for example.

### TECHNICAL FIELD

Embodiments described herein generally relate to mobile wallets and, for example and without limitation, securely revising wallet elements.

### BACKGROUND

Mobile wallets can allow consumers to make payments for products and services with mobile computing devices instead of cash, credit cards or checks.

### DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram showing one example of an environment for mobile wallet revisions.

FIG. 2 is a block diagram illustrating a mobile computing device, according to an example embodiment.

FIG. 3 is a flowchart showing a revision process flow, according to an example embodiment.

FIG. 4 is a flowchart showing a revision process flow, according to an example embodiment.

FIG. 5 is a timing diagram showing an example of a mobile wallet revision process.

FIG. 6 is a diagram showing an example of a revision instructions table.

FIG. 7 is a block diagram illustrating an example of a machine upon which one or more embodiments may be implemented.

### DETAILED DESCRIPTION

A mobile wallet (also known as an electronic or digital wallet) refers to an application program executed by one or more computing devices (e.g., mobile devices such as a smartphone) and corresponding device memory which store and manage digital representations of elements (or items) typically found in a user's wallet or purse. These elements may comprise payment elements and non-payment elements. Payment elements are items which may be used in a financial transaction. Example payment elements managed by the digital wallet include digital representations of transaction cards, financial information, discount coupons, gift cards, subway passes, movie tickets, and so on. Example non-payment elements include digital representations of driver's licenses, passports, student ids, library cards, membership cards, insurance cards, and so on. The mobile wallet application allows an individual to use the stored information to pay for items (either in person or in e-commerce transactions), provide for identification (e.g., producing a driver's license), transfer money to others, access bank accounts, collect discount coupons, submit subway passes, and the like. Exemplary mobile wallets include but are not limited to APPLE PAY®, ANDROID PAY®, GOOGLE WALLET®, CURRENT C® by MCX®, SAMSUNG PAY®, and peer-to-peer payment apps such as VENMO®, SQUARE CASH ®, and TILT APP®.

Users may have multiple mobile wallets in the same computing device and/or in different computing devices. Each of these mobile wallets may include one or more wallet elements. In some cases—for example, with credit card elements a user may have a first mobile wallet holding a first element and a second mobile wallet holding a second element, where both the first and second elements are both associated with the same credit card account. Users may also share elements from the user's mobile wallet to another mobile wallet.

It is important to periodically revise wallet elements to, for example, update the software associated with an element or update expiration dates. With the growing number of mobile wallets and wallet elements, it may become burdensome for element issuers to track and revise wallet elements. Disclosed in some examples are methods, systems, and machine readable mediums for automatically revising wallet elements in a secure fashion. The element revision may be initiated by the mobile wallet rather than the element issuer in order to reduce the burden of the issuer tracking the wallet element.

In some examples, a mobile wallet may store an element issued by an element issuer with revision instructions and a revision signature. The revision instructions may include instructions for when to perform a revision. The revision instruction may, for example, include instructions for obtaining a new element upon a defined expiration date. Upon a revision event such as the expiration date or a date in advance of the expiration date, the mobile wallet can send a revision request and the element's revision signature to the issuer. The request in this instance may be to issue a new element due to expiration. The issuer may reply with a revision package such as a new wallet element and instructions for installing the new element. The mobile wallet may then update or replace the wallet element with the new one received from the issuer. Communications between the mobile wallet and the issuer may be performed using public-private key pairs. For instance, the mobile wallet may use a public key of the issuer to encrypt a revision request and the issuer may use its private key to decrypt the revision request and processes the request.

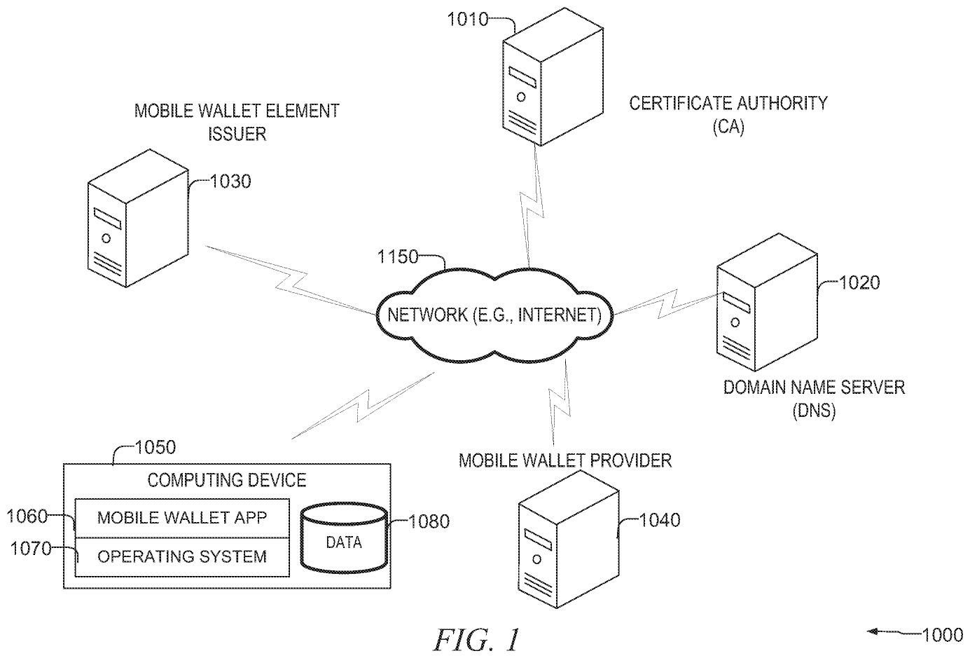

FIG. 1 is a diagram showing an example of an environment 1000 for wallet element revisions. The environment 1000 includes a mobile computing device 1050, a mobile wallet provider 1040, a wallet element issuer 1030, a domain name server (DNS) 1020 and a certificate authority (CA) 1010. As will be appreciated, the environment 1000 may include more than one of the each of the various components 1010-1080. The mobile computing device 1050 may be any computing device suitable for executing a mobile wallet application 1060. Example mobile computing devices may include smart phones, tablet computers, laptop computers, smart watches, etc. The mobile wallet application 1060 (sometimes referred to herein as a mobile wallet), may be executed by a processing unit of the mobile computing device 1050 (not shown in FIG. 1). Additionally, the mobile computing device 1050 may comprise an operating system 1070 and data storage 1080, which may store data for executing the mobile wallet 1060 and revising wallet elements.

The DNS 1020 may contain a database of domain names and their respective intranet protocol (IP) addresses. The mobile wallet 1060 may communicate with DNS 1020 to obtain the IP address for an element issuer. The CA 1010 may issue digital certificates that certify the ownership of public keys. Using the IP address of the issuer and the issuer's public key, the mobile wallet 1060 may securely communicate with element issuer 1030 to revise wallet elements.

The mobile wallet provider 1040 may maintain one or more mobile wallets such as wallet 1060. The mobile wallet provider 1040 may be a financial institution, software company, or any other organization that provides and maintains mobile wallets. The mobile wallet provider 1040 may comprise one or more computing devices, such as servers, and database systems. Computing devices making up the mobile wallet provider 1040 may be located at a single geographic location and/or may be distributed across multiple geographic locations. In some examples, the mobile wallet provider 1040 may be implemented in a “cloud computing” environment or as a “software as a service” (SaaS). For example, at least some of the operations of the mobile wallet provider 1040 may be performed by a group of computing devices, with these operations being accessible via a network, such as the network 1150, and/or via one or more appropriate interfaces (e.g., an Application Program Interface (API)).

The various components of environment 1000 may be in communication with one another via a network 1150. The network 1150 may be or comprise any suitable network element operated according to any suitable network protocol. For example, one or more portions of network 1150may be an ad hoc network, an intranet, an extranet, a virtual private network (VPN)), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a network, a WiMax network, another type of network, or a combination of two or more such networks.

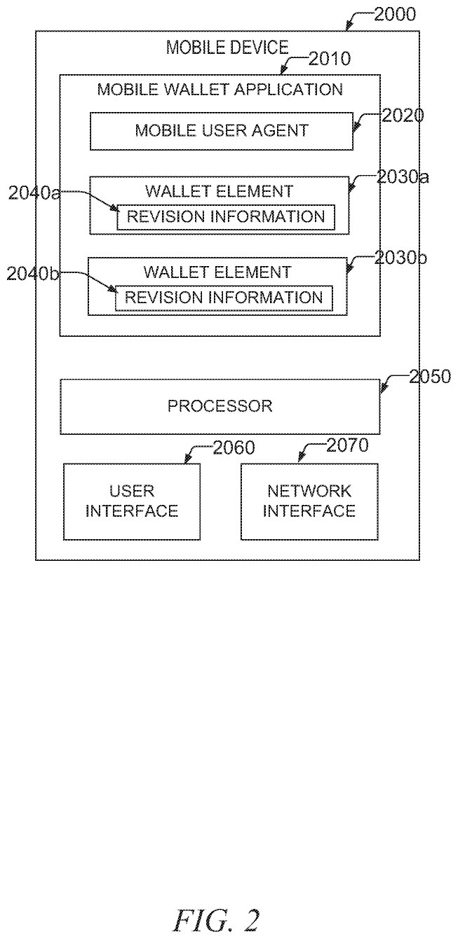

FIG. 2 is a block diagram showing an example architecture of a mobile computing device 2000 that may manage revisions for a wallet element. The computing device 1050, for example, may be implemented according to the architecture 2000. The architecture 2000 includes a mobile wallet application 2010 that includes a mobile user agent (MUA) 2020 and one or more wallet elements such as elements 2030a and 2030b. Two wallet elements are illustrated though fewer or more wallet elements may be included within a mobile wallet. The MUA 2020 may allow a user to create, view, send and/or receive electronic messages. The MUA 2020 may for example communicate with other mobile wallets and issuers using the communication techniques described herein including those described with reference to FIGS. 1-17.

Each wallet element 2030a, b includes its own revision information 2040a, b. The revision information may include one or more revision instructions and a unique revision signature. The mobile wallet 2010 may manage revisions for wallet elements 2030a, b including for example determining when a revision is needed for a wallet element using the wallet element's revision instructions) and requesting the revision from an issuer associated with the element (e.g. using the wallet element's revision signature).

The wallet elements 2030a, b may be self-contained elements that may be moved from a mobile wallet on one mobile device to a mobile wallet on another mobile device, with the wallet elements 2030a, b being transferred along with their respective revision information. This may allow for greater and more secure transfer of mobile wallet elements between devices, may allow for easy revisions to wallet elements independent of the mobile device on which the wallet element resides, and also may reduce the burden on issuers of maintaining wallet elements. When an issuer issues or revises a mobile wallet element and sends it to a mobile wallet, the issuer may embed the revision information in the element. In one embodiment, the issuer may revise the embedded revision element without other part of a mobile wallet element.

The mobile wallet application may be stored on a memory (not shown) accessible by a processor 2050. The processor 2050 may include one or more processors any of a variety of different types of commercially available processors suitable for mobile computing devices (for example, an Advanced RISC Machine (ARM) processor, an XScale architecture microprocessor, a Microprocessor without Interlocked Pipeline Stages (MIPS) architecture processor, or another type of processor). The mobile device architecture 2000 may also include, among other things, a user interface 2060 such as a touch screen display and a network interface 2070 for communicating with a network such as network 1150 of FIG. 1. The wallet elements database 2030a, b including revision information 2040a, b may be stored on a memory (not shown) and accessible to the mobile wallet application 2010 and processor 2050. Memory may be a memory system, such as a Random Access Memory (RAM), a Flash memory, or other type of memory or data storage.

Wallet elements such as elements 2030a, b may include payment service elements and non-payment service elements. Payment service elements be and/or may reference user accounts that can fund a payment including, for example, credit card accounts, debit accounts, checking accounts, etc. Non-payment service elements may be and/or reference, user accounts, memberships, etc. that do not include funds for making a payment. Examples of non-payment service wallet elements include employee cards, insurance cards, membership cards, and driver's licenses. Data stored in a wallet element may include, for example, transaction credentials for a wallet element (e.g., name and account identifiers), identification data uniquely identifying an element, historical usage data describing past uses of an element by the mobile wallet 2010, usage policy data describing when an element may be used, etc.

The revision information 2040a may include one or more revision instructions and a revision signature for wallet element 2040a. Likewise, the revision information 2040b may include one or more revision instructions and a revision signature for wallet element 2040b. Revision instructions may include one or more of a revision time (e.g., when to do a revision), user criteria (e.g., whether a revision is automatic or requires user intervention), issuer data (e.g., the domain name of the issuer of the related element) and revision type (e.g., replacement of element, upgrade of element with new software or data, change to element features or functions, etc.). The revision instructions may be provided by the issuer when issuing a wallet element.

Additional revision instructions may be provided by a user. For example, a user may add revision instructions defining when to request a credit line increase and whether to do so automatically or with user approval. The revision signature for a wallet element (e.g., element 2030a or 2030b) may include a unique signature associated with the particular mobile wallet element. The signature may be a unique object such as a number, symbol, photograph, graphic or other identifier provided by the issuer of the wallet element. The signature may be provided by the issuer when issuing the mobile wallet element.

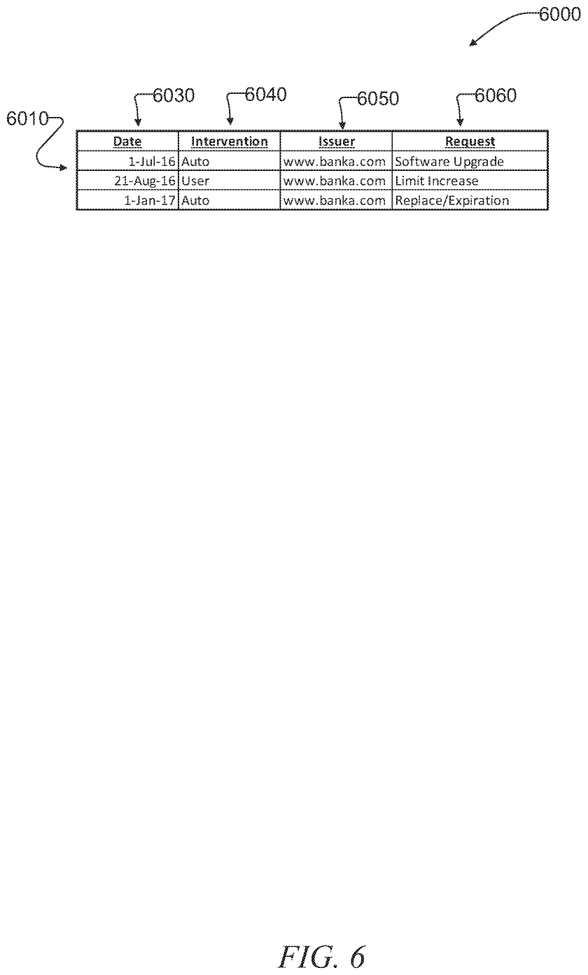

FIG. 6 illustrates example revision information 6000 for a wallet element. The revision information 6000 may include one or more revision instructions 6010. Each revision instruction 6010 may include date data 6030 indicating a date and/or time for the revision, intervention data 6040 indicating whether the revision is automatic or requires user intervention (e.g., approval before sending a revision request), issuer data 6050 such as a domain name for an issuer of the corresponding element, and request data which may indicate the type of revision request such as card replacement or software upgrade.

The revision instructions 6010 are shown by way of example and not limitation. In other embodiments, a revision instruction may include more or fewer data types. A revision instruction may include data types such as a flag indicating that a request has been made to an issuer and a revision signature or a pointer to a revision signature for the revision request, as examples.

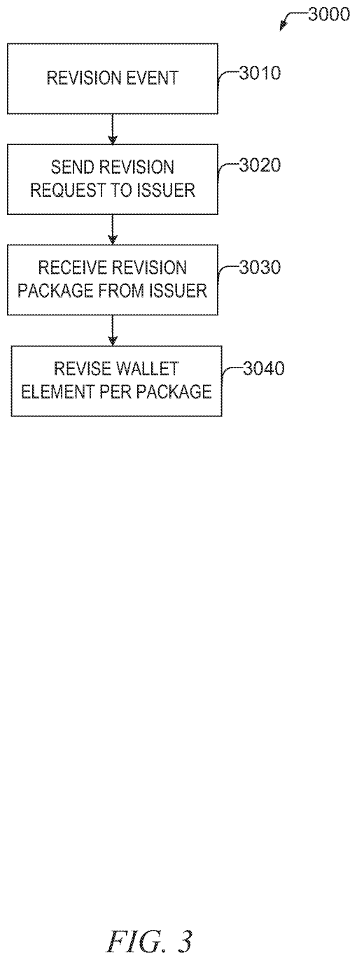

FIG. 3 is a flowchart showing an example of a process flow 3000 that may be executed by mobile wallet to revise a wallet element. At 3010, a revision event may occur. In some examples, a mobile wallet may determine that a revision event has occurred by, for example, checking the revision information of the mobile wallet element(s) in the mobile wallet for revision instructions that are due. An instruction may be considered due when it reaches or passes its date or is within a set time before the date. In some examples, another component, such as a mobile wallet service provider, may determine that a revision event has occurred and may request that the mobile wallet to generate a revision request. A revision event may be any suitable event that prompts the generation of a revision request.

At 3020, the mobile wallet may send a revision request to the issuer of the element associated with the revision event. The revision request may include the revision signature associated with the element and a description of the request revision (e.g., a replacement element, updated software, etc.). The element issuer may compare the revision signature with a database of signatures stored by the issuer to verify the identity of the wallet element. At 3030, the mobile wallet may receive a revision package from the element issuer. The revision package may include revised wallet element data such as a new or replacement wallet element or new software for the element, and may further include instructions for installing the revised element data. At 3040, the mobile wallet may review the wallet element in accordance with the package received from the issuer. In this manner, wallet elements may be revised in a manner initiated by the mobile wallet rather than an issuer. This may reduce the burden on element issuers to track and update wallet elements. The process of requesting a revision and issuing a revised element may be performed securely with cryptography.

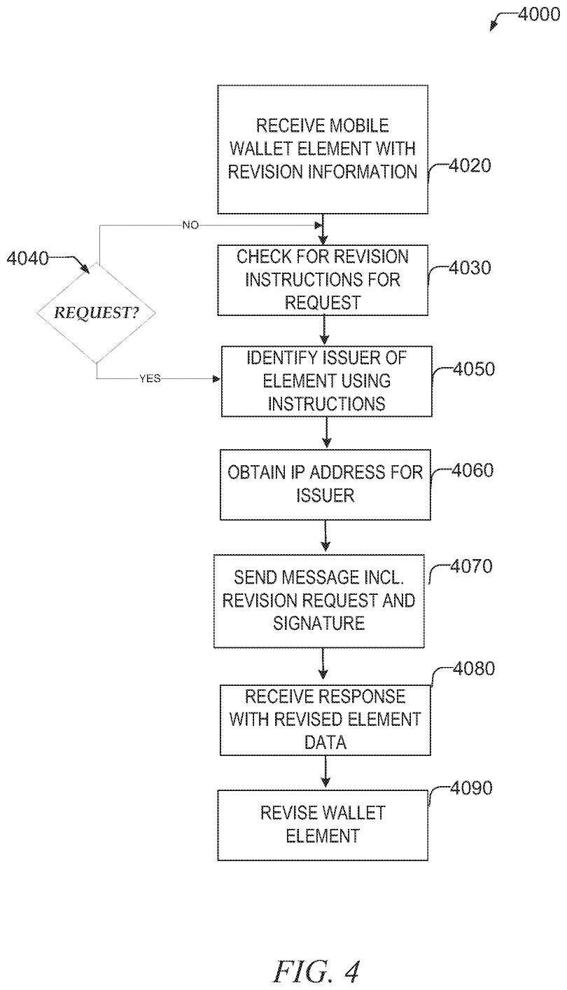

FIG. 4 is a flowchart showing an example of a process flow 4000 that may be executed by mobile wallet to revise a wallet element. The process is described with respect to a mobile wallet application but may also or alternatively be performed by a wallet service provider. At 4020, a mobile wallet may receive a wallet element and revision information for the mobile wallet from an element issuer. The mobile wallet may operate on a computing device, and the wallet element may be stored in a memory of the computing device such as in an elements database. An issuer may, for example, send the mobile wallet the revision instructions and revision signature at the time the wallet element is initially installed. A user may also store revision instructions for the mobile wallet element. For example, a user may set a period schedule for checking on credit limits. The revision instructions and signature may be securely stored on the computing device. The issuer may also store the signature in a database for using in verifying incoming revision requests.

At 4030, the mobile wallet may check the revision instructions for a request to determine whether a revision request for the wallet element is due. For example, a mobile wallet may periodically check revision information on wallet elements for revision requests that are due. This may be done by checking revision time data indicating when a revision is to occur. As indicated at 4040, if a request is identified flows moves to block 4050. If a revision is not identified flow returns typically after a period of time to block 4030 where another request check is made. At 4050, the mobile wallet may identify an issuer of the wallet element using the revision instructions. This may include querying revision information of a wallet element to obtain an issuer for the due revision. At 4060, the mobile wallet may obtain from a first server an IP address for the issuer. The first server may for example be a DNS. In other embodiments, the revision instructions may store the IP address and the mobile wallet may communicate with the issuer without obtaining the IP address from a DNS.

At 4080, the mobile wallet may receive a response to the message from the issuer. The response may include revised wallet element data from the issuer. At 4090, the mobile wallet may revise the wallet element based on the revised wallet element data received from the issuer. In some examples, the mobile wallet may receive user authentication and/or approval prior to revising the mobile wallet element. For example, after identifying a request at 4040, the mobile wallet may prompt a user for authentication and/or approval prior to sending a revision request message at block 4070.

The types of revisions can vary. For example, the revised wallet element data may include a new wallet element and the mobile wallet may replace the wallet element with the new mobile wallet element. As another example, the revised wallet element data may include new revision instructions and the mobile wallet may revise the wallet element by replacing the current revision instructions (e.g., used to generate the revision event) with the new revision instruction. As another example, the revised wallet element data may include a new revision signature and the mobile wallet may replace the revision signature with the new revision signature. In another example, the revised wallet element data may include new data or software for the wallet element. The revised element data can include one or combination of different data or updates for the wallet element. For example, with reference to FIG. 6., when a request to replace an element due to expiration is made (e.g., based on the Jul. 1, 2016 date), the issuer may send revised element data that includes a new revision instruction with a new date Jul. 1, 2017) for a replace for expiration revision request. A similar update may be made for periodic software upgrades.

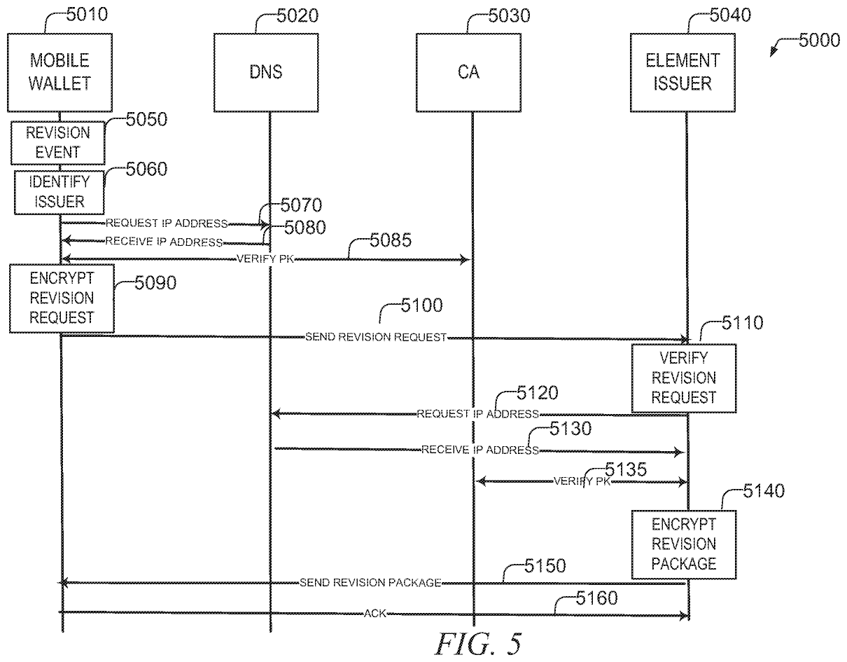

FIG. 5 is a timing diagram showing one example of a mobile wallet revision process 5000 utilizing public key infrastructure. The revision process 5000 may operate using a mobile wallet 5010, a DNS 5020, a CA 5030 and an element issuer 5040. The element issuer 5040 may be a computer system associated with an entity that issues wallet elements. In the timing diagram of FIG. 5, time passes from top to bottom. For example, messages and actions closer to the top of the timing diagram of FIG. 5 may occur before actions that are closer to the bottom. At 5050, the mobile wallet 5010, which may be operating on a mobile device for example, identifies a revision event. This may be performed by periodically checking a revision instructions database to determine if a revision instruction has become due (e.g., a credit card element has or is about to reach an expiration date). At 5060, the mobile wallet 5010 identifies the issuer of the wallet element associated with the identified revision update. The issuer may be identified by domain name, with the domain name associated with the wallet element in a database accessible to the mobile wallet (e.g., a revision instructions database or a wallet elements database). While process 5000 is described with respect to a mobile device, other computing devices or a wallet service provider may perform the process in other examples.

At 5070, the mobile wallet sends a message with the domain name of the issuer to DNS 5020, requesting the IP address for the issuer. At 5080, the mobile wallet receives a response from the DNS that includes the IP address of the issuer. The mobile wallet may obtain the issuer's public key as part of a certificate or separately from the issuer (e.g., through a browser request) and may verify the public key with CA 5030 as indicated at 5085. In other embodiments, the mobile wallet may access a keychain or other storage location, stored on the mobile wallet computing device or remotely, to obtain the public key for the issuer.

Using the public key, the mobile wallet 5010 may encrypt a revision request message 5090 and the request 5090 may be sent to the element issuer as indicated at 5100. The revision request message may include the revision signature for the wallet element being revised as well as the revision action. The mobile wallet 5010 may send the revision request over a network such as network 1150 shown in FIG. 1. The mobile wallet 5010 may communicate with other systems such as the DNS 5020, CA 5030 and issuer 5040 using the various communication techniques discussed herein including those described with reference to FIGS. 1-17.

At 5110, the element issuer 5040 may verify the revision request. This may be performed by comparing a wallet element signature received from the mobile wallet in the message request 5100 with a signature maintained by the issuer to determine a match. After verification 5110, as indicated at 5120 and 5130, the element issuer 5040 may request and receive the IP address for the mobile wallet 5010 from DNS 5020. The element issuer may verify the public key of the mobile wallet as indicated at 5135. The element issuer may locally store the public key of the mobile wallet and use CA 5030 for verification.

At 5140, the element issuer 5040 encrypts a revision package using the public key of the mobile wallet and sends the revision package to the mobile wallet 5010 as indicated at 5150. The mobile wallet 5010 may respond with an acknowledgement confirming receipt of the package as indicated at 5160. The mobile wallet 5010 may then revise the wallet element in accordance with the revision package. In some embodiments, the revision package may include instructions so that the mobile wallet computing device can install the revisions.

The revision package as noted above may include revised data for the wallet element in accordance with the revision action. For example, where the revision action indicates card expiration, the element issuer may include in the revision package a new expiration date for the wallet element. The element issuer may periodically or with each revision request package include a new revision signature for the wallet element (and may store the signature locally to use for verification). The revision package may further include new features or software upgrades for the wallet element.

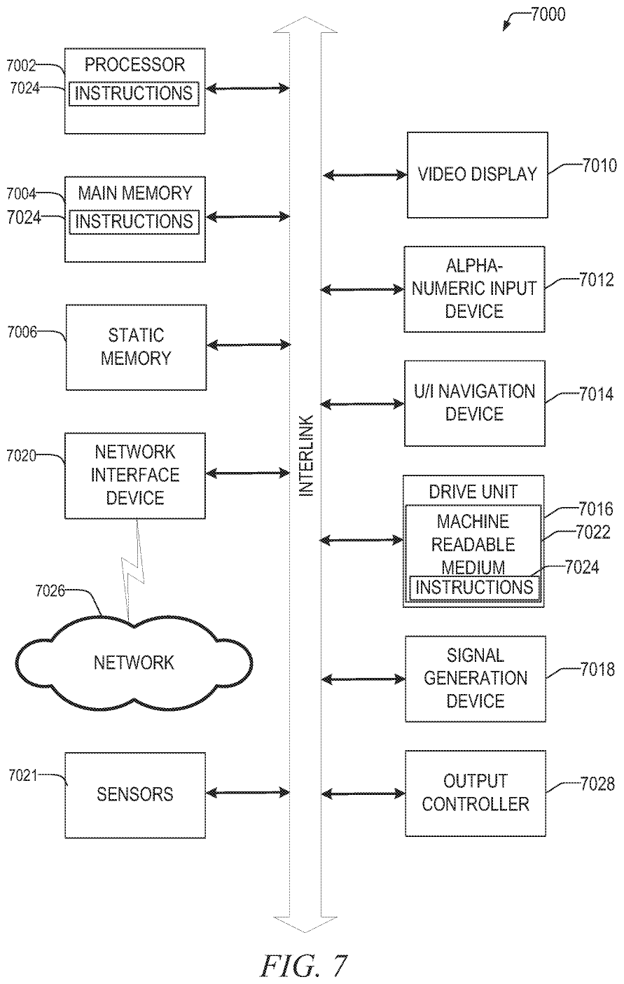

FIG. 7 illustrates a block diagram of an example machine 7000 upon which any one or more of the techniques (e.g., methodologies) discussed herein may perform. In alternative embodiments, the machine 7000 may operate as a standalone device or may be connected (e.g., networked) to other machines. In a networked deployment, the machine 7000 may operate in the capacity of a server machine, a client machine, or both in server-client network environments. In an example, the machine 7000 may act as a peer machine in peer-to-peer (P2P) (or other distributed) network environment. The machine 7000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine 7000 may function as an MUA, MTA, computing device executing a mobile wallet application, DNS, CA, PKS, Key Manager, Key Keeper, or the like. For example, the Machine 7000 may be configured to perform any of the operations of discussed above. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 7000 may include a hardware processor 7002 (e.g., a central processing unit (CPU), a graphics processing unit (GPU), a hardware processor core, or any combination thereof), a main memory 7004 and a static memory 7006, some or all of which may communicate with each other via an interlink (e.g., bus) 7008. The machine 7000 may further include a display unit 7010, an alphanumeric input device 7012 (e.g., a keyboard), and a user interface (UI) navigation device 7014 (e.g., a mouse). In an example, the display unit 7010, input device 7012 and UI navigation device 7014 may be a touch screen display. The machine 7000 may additionally include a storage device (e.g., drive unit) 7016, a signal generation device 7018 (e.g., a speaker), a network interface device 7020, and one or more sensors 7021, such as a global positioning system (GPS) sensor, compass, accelerometer, or other sensor. The machine 7000 may include an output controller 7028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 7016 may include a machine readable medium 7022 on which is stored one or more sets of data structures or instructions 7024 (e.g., software) embodying or utilized by any one or more of the techniques or functions described herein. The instructions 7024 may also reside, completely or at least partially, within the main memory 7004, within static memory 7006, or within the hardware processor 7002 during execution thereof by the machine 7000. In an example, one or any combination of the hardware processor 7002, the main memory 7004, the static memory 7006, or the storage device 7016 may constitute machine readable media.

While the machine readable medium 7022 is illustrated as a single medium, the term “machine readable medium” may include a single medium or multiple media (e.g., a centralized or distributed database, and/or associated caches and servers) configured to store the one or more instructions 7024.

The term “machine readable medium” may include any medium that is capable of storing, encoding, or carrying instructions for execution by the machine 7000 and that cause the machine 7000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 7024 may further be transmitted or received over a communications network 7026 using a transmission medium via the network interface device 7020. The Machine 7000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area. network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 7020 may include one or more physical jacks (e.g., Ethernet, coaxial, or phone jacks) or one or more antennas to connect to the communications network 7026. In an example, the network interface device 7020 may include a plurality of antennas to wirelessly communicate using at least one of single-input multiple-output (SIMO), multiple-input multiple-output (MIMO), or multiple-input single-output ISO) techniques. In some examples, the network interface device 7020 may wirelessly communicate using Multiple User MIMO techniques.

1. A method of securely revising mobile wallet elements, the method comprising:
receiving, in a memory of a computing device, a wallet element for a mobile wallet, the wallet element including at least one revision instruction and a revision signature for the wallet element, the revision instruction including intervention data indicating whether the revision is automatic;
determining, at one or more processors, that a revision is due based on the revision instruction, the determination being based on a defined expiration date on which a new element is to be obtained;
identifying, at the one or more processors, an issuer of the wallet element using the revision instruction;
sending, from the one or more processors, a message to an IP address of the issuer of the mobile wallet element, the message being encrypted using a public key of the issuer and including a revision request and the revision signature of the mobile wallet element;
receiving, at the one or more processors, a response to the message from the issuer, the response including:
revised wallet element data from the issuer; and
instructions for installing the revised element data, the response being encrypted with a public key associated with the mobile wallet thereby securing the revised wallet element data;
decrypting the received response with a private key associated with the mobile wallet; and
revising, by installing the revised element data with the one or more processors, the wallet element based on the revised wallet element data received from the issuer.

2. The method of claim 1, wherein the revised wallet element data includes a new wallet element and wherein revising the wallet element includes replacing the wallet element with the new wallet element.

3. The method of claim 1, wherein the revised wallet element data includes a new revision instruction and wherein revising the wallet element includes replacing the revision instruction with the new revision instruction.

4. The method of claim 1, wherein the revised wallet element data includes a new revision signature and wherein revising the wallet element includes replacing the revision signature with the new revision signature.

5. The method of claim 1, wherein the revised wallet element data includes a new revision instruction and a new revision signature, and wherein revising the wallet element includes replacing the revision instruction with the new revision instruction and replacing the revision signature with the new revision signature.

6. The method of claim 1, further including receiving user authentication prior to revising the wallet element.

7. The method of claim 1, wherein the revised wallet element data includes a new expiration date for the wallet element.

8. The method of claim 1, wherein the revised wallet element data includes one or more of new software, new data and new functionality for the wallet element.

9. The method of claim 1, wherein the revision instruction includes one or more of element data, date data, intervention data, issuer data, and request data.

10. The method of claim 1, wherein the at least one revision instruction includes an instruction from an issuer.

11. The method of claim 10, wherein the at least one revision instruction includes an instruction from a user.

12. (canceled)

13. (canceled)

14. The method of claim 1, further including sending an acknowledgement message to the issuer after at least one of receiving the received response and decrypting the received response.

15. A non-transitory computer-readable storage medium, the computer-readable storage medium including instructions to securely revise mobile wallet elements, where the instructions, when executed by a computer, cause one or more processors of the computer to perform operations of:
receiving a wallet element for a mobile wallet, the wallet element including at least one revision instruction and a revision signature for the wallet element, the revision instruction including intervention data indicating whether the revision is automatic;
determining that a revision is due based on the revision instruction, the determination being based on a defined expiration date on which a new element is to be obtained;
identifying an issuer of the wallet element using the revision instruction;
sending a message to an IP address of the issuer of the mobile wallet element, the message being encrypted using a public key of the issuer and including a revision request and the revision signature of the mobile wallet element;
receiving a response to the message from the issuer, the response including:
revised wallet element data from the issuer; and
instructions for installing the revised element data, the response being encrypted with a public key associated with the mobile wallet thereby securing the revised wallet element data;
decrypting the received response with a private key associated with the mobile wallet; and
revising, by installing the revised element data. the wallet element based on the revised wallet element data received from the issuer.

16. The medium of claim 15, wherein the revised wallet element data includes a new revision instruction and wherein revising the wallet element includes replacing the revision instruction with the new revision instruction.

17. The medium of claim 16, wherein the revised wallet element data includes a new revision signature and wherein revising the wallet element includes replacing the revision signature with the new revision signature.

18. A system for secure revising mobile wallet elements, the system comprising:
at least one processor; and
at least one storage device comprising instructions, which when executed by the at least one processor, configure to at least one or more processors to perform operations comprising:
receiving a wallet element for a mobile wallet, the wallet element including at least one revision instruction and a revision signature for the wallet element, the revision instruction including intervention data indicating whether the revision is automatic;
determining that a revision is due based on the revision instruction, the determination being based on a defined expiration date on which a new element is to be obtained;
identifying an issuer of the wallet element using the revision instruction;
sending a message to an IP address of the issuer of the mobile wallet element, the message being encrypted using a public key of the issuer and including a revision request and the revision signature of the mobile wallet element;
receiving a response to the message from the issuer, the response including:
revised wallet element data from the issuer, and
instructions for installing the revised element data, the response being encrypted with a public key associated with the mobile wallet thereby securing the revised wallet element data;
decrypting the received response with a private key associated with the mobile wallet; and
revising, by installing the revised element data, the wallet element based on the revised wallet element data received from the issuer.

19. The system of claim 18, wherein the revised wallet element data includes a new revision instruction and a new revision signature, and wherein revising the wallet element includes replacing the revision instruction with the new revision instruction and replacing the revision signature with the new revision signature.

20. The system of claim 19, the operations further include receiving user authentication prior to revising the wallet element.
